(19) United States
(12) Patent Application Publication
(10) Pub. No.: US 2014/0106109 A1
(43) Pub. Date: Apr. 17, 2014

(54) METAL ORNAMENT AND METHOD FOR MANUFACTURING METAL ORNAMENT

(71) Applicant: KABUSHIKI KAISHA TOKAI RIKA DENKI SEISAKUSHO, Aichi (JP)

(72) Inventor: Bunji INAGAKI, Aichi (JP)

(73) Assignee: KABUSHIKI KAISHA TOKAI RIKA DENKI SEISAKUSHO, Aichi (JP)

(21) Appl. No.: 14/045,864

(22) Filed: Oct. 4, 2013

(30) Foreign Application Priority Data
Oct. 12, 2012 (JP) 2012-227156

(51) Int. Cl. B44C 5/04; B44F 3/00

(52) U.S. Cl. CPC B44C 5/0453; B44F 3/00
USPC 428/67; 29/896.4

(57) ABSTRACT

A method for manufacturing a metal ornament including an ornamental portion by processing a metal plate. The method includes forming a first resin piece including a recess corresponding to the ornamental portion on one surface of the plate, forming an opening in the plate by cutting the plate along the recess, and forming a second resin piece shaped in conformance to the ornamental portion in the plate by filling the opening and the recess with a resin. When the cut plate includes a main body and an island separated from the main body, the first resin piece is formed to include an extension that supports the island.

### BACKGROUND OF THE INVENTION

The present invention relates to metal ornament and a method for manufacturing a metal ornament.

A metal ornament formed by processing metal may have the form of a character, such as an English alphabet. Such a metal ornament is often formed in a pressing process (refer to, for example, Japanese Laid-Open Patent Publication No. 6-210366).

FIGS. 7A and 7B show metal ornaments with the English alphabets of P and O. Each metal ornament includes a main body 51, an island 52 separated (isolated) from the main body 51, and a bridge 53, which keeps the island 52 connected to the main body 51. It is desirable that the bridge 53 be omitted to improve the ornamentality of the metal ornament.

### SUMMARY OF THE INVENTION

A first aspect of the present invention is a method for manufacturing a metal ornament including an ornamental portion. The method includes forming a first resin piece including a recess corresponding to the ornamental portion on one surface of a metal plate, forming an opening in the plate by cutting the plate along the recess, and forming a second resin piece shaped in conformance to the ornamental portion in the plate by filling the opening and the recess with a resin. When the cut plate includes a main body and an island separated from the main body, the forming a first resin piece includes forming the first resin piece to include an extension that supports the island.

A second aspect of the present invention is a metal ornament including an ornamental portion. The metal ornament includes a metal plate including an opening corresponding to the ornamental portion. A first resin piece is formed on one surface of the plate. The first resin piece includes a recess corresponding to the ornamental portion. When the plate includes a main body and an island separated from the main body, the first resin piece includes an extension that supports the island. A second resin piece is arranged in the opening and the recess. The second resin piece is shaped in conformance to the ornamental portion.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing a metal ornament according to one embodiment of the present invention;

FIG. 2 is an exploded perspective view of the metal ornament shown in FIG. 1;

FIG. 3 is a cross-sectional view taken along line II-II in FIG. 1;

FIGS. 4A and 4B are perspective views illustrating a first resin molding step;

FIGS. 5A to 5C are cross-sectional views showing a cutting step and a second resin molding step;

FIG. 6 is a diagram showing an example in which the metal ornament is used to transmit light; and

FIGS. 7A and 7B are schematic diagrams of conventional metal ornaments.

### DETAILED DESCRIPTION OF THE INVENTION

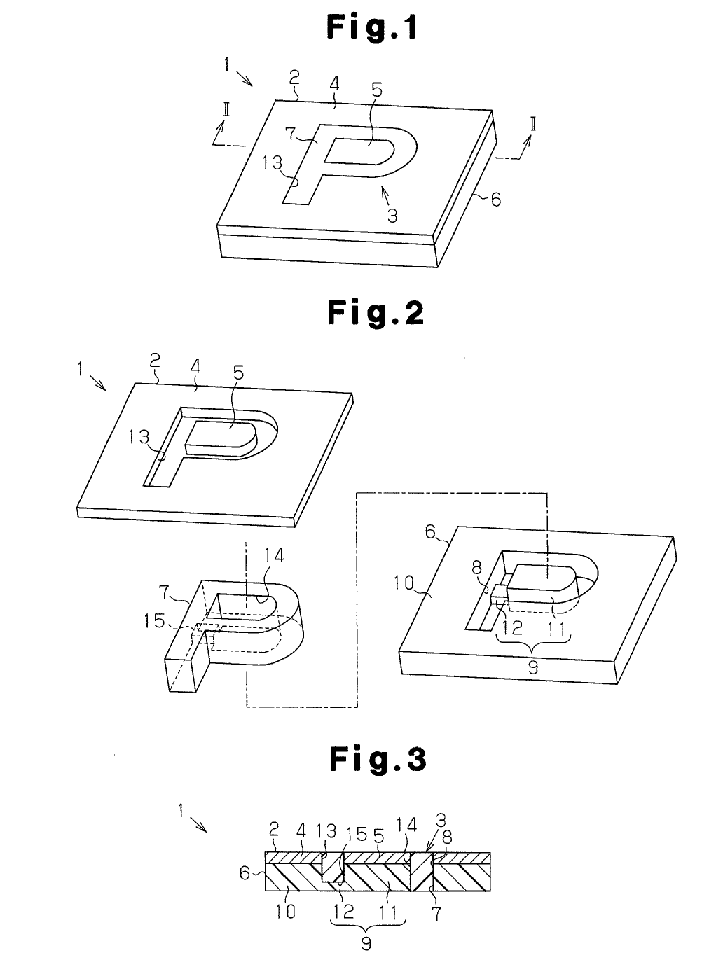

A metal ornament and a method for manufacturing a metal ornament according to one embodiment of the present invention will now be described with reference to FIGS. 1 to 6.

Referring to FIG. 1, a metal ornament 1 includes a planar metal plate 2 and an ornamental portion 3, which is formed in the plate 2 and has the shape of, for example, the English alphabet P. Since the ornamental portion 3 is P-shaped, the metal plate 2 includes a main body 4 and an island 5, which is separated (isolated) from the main body 4. The island 5, which is separated from the main body 4, needs to be held in the plate 2 with the main body 4. When the plate 2 includes the island 5, the ornamental portion 3 may have the shape of, for example, the English alphabets of O or R.

Referring to FIGS. 2 and 3, the metal ornament 1 includes a first resin piece 6, which serves as a seat for the plate 2, and a second resin piece 7, which is shaped in conformance with the ornamental portion 3. Preferably, the first resin piece 6 and the second resin piece 7 are formed from a material that ensures adhesion of the plate 2, the first resin piece 6, and the second resin piece 7 to one another. The first resin piece 6 includes a recess 8 formed conforming to the shape of the ornamental portion 3. Further, the first resin piece 6 includes a main resin body 10 and an extension 9, which extends from the main resin body 10 at the central part of the recess 8. The extension 9 supports a rear side of the island 5. Further, the extension 9 includes a support 11, which contacts and supports the island 5, and a bridge 12, which connects the support 11 to the main resin body 10. The bridge 12 may have any shape as long as it connects the support 11 and the main resin body 10.

The second resin piece 7 is arranged in the recess 8 of the first resin piece 6 and an opening 13 of the plate 2. The opening 13 is shaped in conformance with the ornamental portion 3. A hole 14, which receives the support 11, extends through a central part of the second resin piece 7. A rear surface of the second resin piece 7 includes a groove 15, which receives the bridge 12.

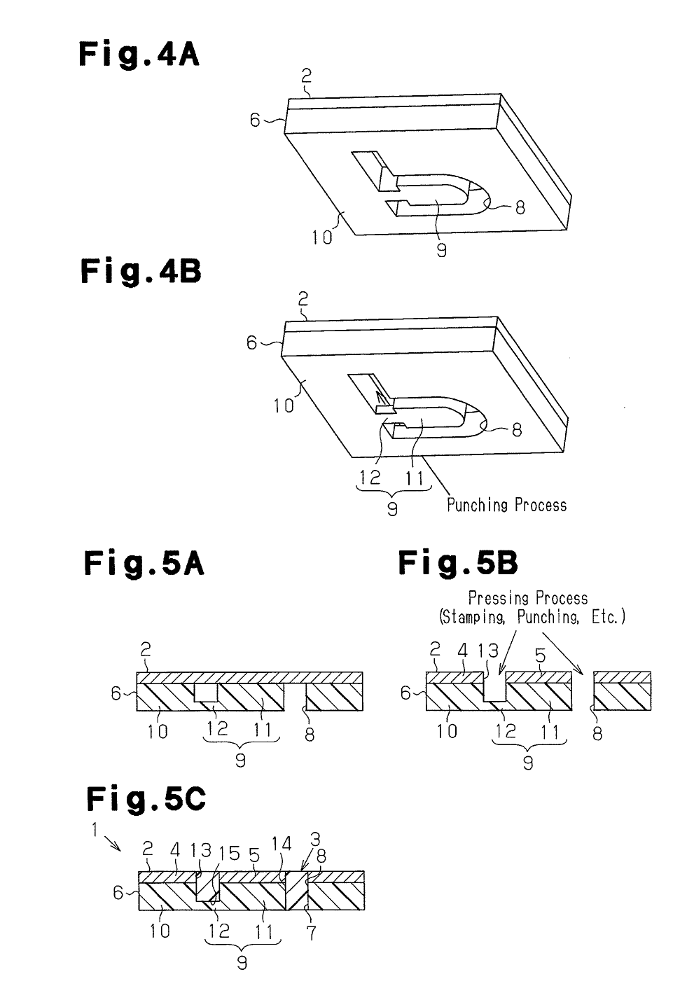

A method for manufacturing the metal ornament 1 will now be described with reference to FIGS. 4A to 6.

Referring to FIG. 4A, the first resin piece 6 is molded onto one surface of the plate 2 (first resin piece molding step). For example, insert molding may be performed to mold the first resin piece 6. Further, the first resin piece 6 is molded to include a portion corresponding to the extension 9 (support 11 and bridge 12). Then, referring to FIG. 4B, the neck of the extension 9 is partially punched out and removed along a planar direction of the plate 2 to form the bridge 12.

The first resin piece 6 is formed as shown in FIG. 5A. Then, referring to FIG. 5B, the plate 2 undergoes a pressing process (cutting step). The pressing process may be a stamping process or a punching process. The plate 2 is pressed along the recess 8 of the first resin piece 6. The recess 8 is shaped in correspondence with the ornamental portion 3 that is formed in the plate 2. The pressing of the plate 2 forms the opening 13, which is shaped to conform to the ornamental portion 3, and exposes the recess 8 of the first resin piece 6.

Referring to FIG. 5C, after pressing the plate 2, the second resin piece 7 is molded in the opening 13 of the plate 2 and the recess 8 of the first resin piece 6 (second resin piece molding step). For example, insert molding may be performed to mold the second resin piece 7. When performing insert molding, resin is filled in the opening 13 and the recess 8 to form the second resin piece 7 in the opening 13 and the recess 8. This forms the ornamental portion 3 with the second resin piece 7 in the plate 2 and completes the metal ornament 1.

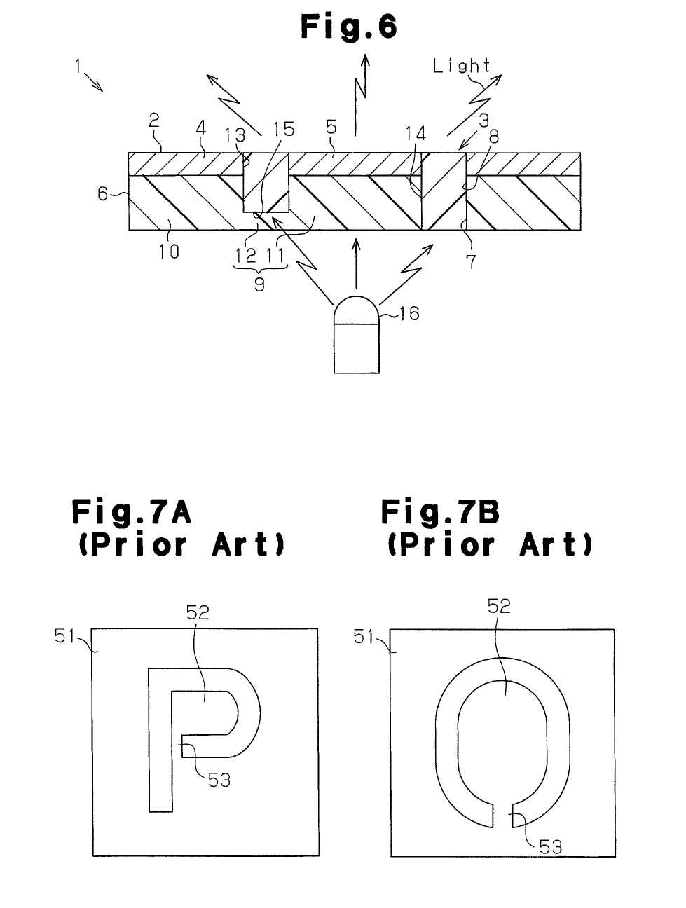

Referring to FIG. 6, the first resin piece 6 and the second resin piece 7 may be formed from a transparent resin. In this case, a light source 16 may be arranged at the rear side of the metal ornament 1 to illuminate the metal ornament 1 from the rear side with light from the light source 16. The transparent resin may be, for example, polycarbonate(PC) or polymethyl methacrylate (PMMA). In this structure, the metal ornament 1 may be used to transmit light. This further improves the ornamentality of the metal ornament 1.

The present embodiment has the advantages described below.

(1) The first resin piece molding step, which molds the first resin piece 6 on the plate 2 in conformance to the ornamental portion 3, the cutting step, which cuts the plate 2 and forms a frame for the ornamental portion 3 (opening 13 and recess 8), and the second resin piece molding step, which fills the frame with resin, are performed to form the metal ornament 1. In the first resin piece molding step, when the first resin piece 6, which is formed on the rear surface of the plate 2, includes the recess 8, which is shaped in conformance to the ornamental portion 3 of the plate 2, and the ornamental portion 3 includes the island 5, the extension 9 supports the island 5 from the rear. In this structure, the first resin piece 6 constantly supports the island 5 in a state connected to the main body 4. Thus, even when the ornamental portion 3 has a shape that includes the island 5, there is no need to change the shape of the ornamental portion 3. This ensures high ornamentality.

(2) In the manufacturing process, the island 5 is connected to the main body 4 and constantly supported by the first resin piece 6. Thus, displacement of the island 5 does not occur in the manufacturing step, and changes in the shape of the ornamental portion are suppressed.

(3) The first resin piece 6 and the second resin piece 7 are insert-molded. Thus, the first resin piece 6 and the second resin piece 7 may be easily formed.

(4) When the first resin piece 6 and the second resin piece 7 are formed from a transparent resin, the metal ornament 1 may transmit light from the light source 16 arranged at the rear side of the metal ornament 1. By illuminating the metal ornament 1 with light from the rear, light from the light source 16 may be emitted to the exterior through the first resin piece 6 and the second resin piece 7. This increases the variations of modes, including lighting modes, in which the metal ornament 1 may be used.

(5) The neck of the extension 9 is punched to form the bridge 12. This allows for the bridge 12 to be easily formed.

It should be apparent to those skilled in the art that the present invention may be embodied in many other specific forms without departing from the spirit or scope of the invention. Particularly, it should be understood that the present invention may be embodied in the following forms.

The first resin piece 6 and the second resin piece 7 do not have to be formed through insert molding. Other processes, such as a potting process, may be performed to form the first resin piece 6 and the second resin piece 7.

Depending on the shape of the ornamental portion, there may be more than one island 5.

When forming the second resin piece 7, for example, a snap-fitting portion may be simultaneously formed, and the snap-fitting portion may be used to couple the metal ornament 1 to another component.

The cutting process does not have to be a pressing process and may be another process such as a laser cutting process.

The first resin piece 6 and the second resin piece 7 may be formed from different materials.

The first resin piece 6 and the second resin piece 7 may be formed from a non-transparent resin and a transparent resin, respectively.

The first resin piece 6 and the second resin piece 7 may both be formed from a non-transparent resin.

The present examples and embodiments are to be considered as illustrative and not restrictive, and the invention is not to be limited to the details given herein, but may be modified within the scope and equivalence of the appended claims.

1. A method for manufacturing a metal ornament including an ornamental portion, the method comprising:
forming a first resin piece including a recess corresponding to the ornamental portion on one surface of a metal plate;
forming an opening in the plate by cutting the plate along the recess; and
forming a second resin piece shaped in conformance to the ornamental portion in the plate by filling the opening and the recess with a resin, wherein when the cut plate includes a main body and an island separated from the main body, the forming a first resin piece includes forming the first resin piece to include an extension that supports the island.

2. The method according to claim 1, wherein the first resin piece and the second resin piece are formed through insert molding.

3. The method according to claim 1, wherein the first resin piece and the second resin piece are formed from a transparent resin that allows for transmission of light.

4. The method according to claim 1, wherein the forming a first resin includes forming a portion of the extension by punching out a portion of the first resin piece along a planar direction of the plate.

5. The method according to claim 1, wherein the forming a first resin includes forming the first resin piece to include a main resin body and the extension, and the extension includes a support, which supports the island, and a bridge, which connects the support and the main resin body.

6. A metal ornament including an ornamental portion, the metal ornament comprising:
a metal plate including an opening corresponding to the ornamental portion;
a first resin piece formed on one surface of the plate, wherein the first resin piece includes a recess corresponding to the ornamental portion, and when the plate includes a main body and an island separated from the main body, the first resin piece includes an extension that supports the island; and
a second resin piece arranged in the opening and the recess, wherein the second resin piece is shaped in conformance to the ornamental portion.

7. The metal ornament according to claim 6, wherein the first resin piece and the second resin piece are formed from a transparent resin that allows for transmission of light.

8. The metal ornament according to claim 6, wherein the first resin piece includes
a resin main body, and
an extension including a support, which supports the island, and a bridge, which connects the support to the resin main body.
